(19) United States
(12) Patent Application Publication
(10) Pub. No.: US 2021/0295245 A1
(43) Pub. Date: Sep. 23, 2021

(54) MANAGEMENT DEVICE, MANAGEMENT METHOD, AND STORAGE MEDIUM

(71) Applicant: HONDA MOTOR CO., LTD., Tokyo (JP)

(72) Inventors: Koichi Ogura, Tokyo (JP); Kensaku Yamamoto, Wako-shi (JP); Ryohei Iwaki, Wako-shi (JP); Yurie Kondo, Tokyo (JP); Yusuke Kawada, Wako-shi (JP)

(21) Appl. No.: 17/202,388

(22) Filed: Mar. 16, 2021

(30) Foreign Application Priority Data
Mar. 18, 2020 (JP) 2020-047375

(51) Int. Cl. G06Q 10/08; G05D 1/00; G05D 1/02

(52) U.S. Cl. CPC G06Q 10/087; G06Q 10/0833; G05D 2201/0216; G05D 1/0212; G05D 1/0088

(57) ABSTRACT

A management device for managing an operation of a cargo transportation vehicle that autonomously travels on a road in a state in which there is no driver in the cargo transportation vehicle and that is able to store cargo in each of a plurality of storages shielded by doors that are opened and closed includes a receiver configured to receive request information about transportation of the cargo from a user, an information provider configured to provide a time at which the cargo transportation vehicle will arrive at a delivery destination of the cargo to a terminal device of a recipient of the cargo, and an operation determiner configured to determine an operation of the cargo transportation vehicle so that the cargo transportation vehicle arrives at the delivery destination at the time.

### CROSS-REFERENCE TO RELATED APPLICATION

Priority is claimed on Japanese Patent Application No. 2020-047375, filed Mar. 18, 2020, the content of which is incorporated herein by reference.

### BACKGROUND

### Field of the Invention

The present invention relates to a management device, a management method, and a storage medium.

### Description of Related Art

An invention related to an unmanned delivery system for delivering cargo using an autonomous moving device that can move autonomously and a server system that operates in association with the autonomous moving device has been disclosed (Japanese Unexamined Patent Application, First Publication No. 2018-058656).

The above-described conventional technology is for loading cargo into an autonomous moving device in a warehouse and is not sufficiently convenient for users.

### SUMMARY

The present invention has been made in view of the above-described circumstances and an objective of the present invention is to provide a management device, a management method, and a storage medium capable of improving convenience.

A management device, a management method, and a storage medium according to the present invention adopt the following configurations.

(1): According to an aspect of the present invention, there is provided a management device for managing an operation of a cargo transportation vehicle that autonomously travels on a road in a state in which there is no driver in the cargo transportation vehicle and that is able to store cargo in each of a plurality of storages shielded by doors that are opened and closed, the management device including: a receiver configured to receive request information about transportation of the cargo from a user; an information provider configured to provide a time at which the cargo transportation vehicle will arrive at a delivery destination of the cargo to a terminal device of a recipient of the cargo; and an operation determiner configured to determine the operation of the cargo transportation vehicle so that the cargo transportation vehicle arrives at the delivery destination at the time.

(2): In the above-described aspect (1), when the cargo transportation vehicle has arrived at the delivery destination, the operation determiner causes the cargo transportation vehicle to depart from the delivery destination after the cargo transportation vehicle is allowed to wait for a predetermined time period, the receiver receives a request for extending a time period for which the cargo transportation vehicle is allowed to wait near the delivery destination after the cargo transportation vehicle arrives at the delivery destination, and the operation determiner extends the time period for which the cargo transportation vehicle is allowed to wait in response to the received request.

(3): In the above-described aspect (2), an upper limit is defined in the number of received requests for the extension.

(4): In the above-described aspect (2) or (3), the operation determiner causes the cargo transportation vehicle to depart from the delivery destination when the receiver has not received the request, the cargo has not been taken out from the cargo transportation vehicle, and a first time period has elapsed from the time at which the cargo transportation vehicle has arrived at the delivery destination, and the operation determiner causes the cargo transportation vehicle to depart from the delivery destination when the receiver has received the request, the cargo has not been taken out from the cargo transportation vehicle, and a second time period has elapsed from an end point of the first time period.

(5): In the above-described aspect (4), the second time period is longer than the first time period.

(6): In any one of the above-described aspects (2) to (5), the information provider provides the terminal device of the recipient with a notification including specific information indicating that receipt has not been performed (for example, receipt has not been taken the stored cargo out from a storage) when the cargo transportation vehicle has departed from the delivery destination in a state in which the cargo has not been taken out from the cargo transportation vehicle and the specific information includes a screen in which redelivery of the cargo is able to be set and information for accessing the screen.

(7): In the above-described aspect (6), the operation determiner causes the cargo transportation vehicle to travel toward a predetermined shop or a designated place so that the cargo is transported to the shop or the designated place for the recipient to receive the cargo at the shop or the designated place when the cargo transportation vehicle has departed from the delivery destination in a state in which the cargo has not been taken out from the cargo transportation vehicle.

(8): In any one of the above-described aspects (2) to (7), the management device further includes a behavior information acquirer configured to acquire information of behavior of the recipient, wherein, after the cargo transportation vehicle departs from the delivery destination in a state in which the cargo has not been taken out from the cargo transportation vehicle, the operation determiner causes the cargo transportation vehicle to stop at a predetermined position so that the recipient receives the cargo when the behavior information acquirer has acquired information indicating that the recipient is approaching the cargo transportation vehicle or information indicating that the recipient intends to receive the cargo.

(9): In any one of the above-described aspects (2) to (8), the operation determiner causes the cargo transportation vehicle to stop at a predetermined position when a first button provided in the cargo transportation vehicle or a second button displayed on a display of the terminal device of the recipient has been operated within a predetermined period from the departure of the cargo transportation vehicle from the delivery destination or while the cargo transportation vehicle travels a predetermined distance from the departure from the delivery destination.

(10) In the above-described aspect (9), the operation determiner causes the cargo transportation vehicle to stop at the predetermined position when the second button displayed on the display of the terminal device of the recipient present within the predetermined distance from the cargo transportation vehicle has been operated and the operation determiner does not cause the cargo transportation vehicle to stop at the predetermined position when the second button displayed on the display of the terminal device of the recipient absent within the predetermined distance from the cargo transportation vehicle has been operated.

(11): In any of the above-described aspects (1) to (10), the management device further includes a fee processor configured to request the recipient to pay an additional fee when the recipient has received the cargo after the cargo transportation vehicle departed from the delivery destination in a state in which the cargo was not taken out from the cargo transportation vehicle when the cargo transportation vehicle arrived at the delivery destination.

(12): In the above-described aspect (11), the operation determiner causes the cargo transportation vehicle to be operated in a first operation mode after the cargo transportation vehicle departs from the delivery destination in a state in which the cargo is taken out from the cargo transportation vehicle when the cargo transportation vehicle has arrived at the delivery destination and the operation determiner causes the cargo transportation vehicle to be operated in a second operation mode having higher agility than the first operation mode after the cargo transportation vehicle departs from the delivery destination in a state in which the cargo is not taken out from the cargo transportation vehicle when the cargo transportation vehicle has arrived at the delivery destination.

(13): According to another aspect of the present invention, there is provided a management method includes: receiving, by a management device, request information about transportation of cargo from a user, the management device managing an operation of a cargo transportation vehicle that autonomously travels on a road in a state in which there is no driver in the cargo transportation vehicle and that is able to store cargo in each of a plurality of storages shielded by doors that are opened and closed; providing, by the management device, a time at which the cargo transportation vehicle will arrive at a delivery destination of the cargo to a terminal device of a recipient of the cargo; and determining, by the management device, the operation of the cargo transportation vehicle so that the cargo transportation vehicle arrives at the delivery destination at the time.

(14): According to yet another aspect of the present invention, there is provided a non-storage medium storing a program for causing a computer of a management device for managing an operation of a cargo transportation vehicle that autonomously travels on a road in a state in which there is no driver in the cargo transportation vehicle and that is able to store cargo in each of a plurality of storages shielded by doors that are opened and closed, to execute processes of: receiving request information about transportation of the cargo from a user; providing a time at which the cargo transportation vehicle will arrive at a delivery destination of the cargo to a terminal device of a recipient of the cargo; and determining the operation of the cargo transportation vehicle so that the cargo transportation vehicle arrives at the delivery destination at the time.

According to the aspects (1) to (14), convenience can be improved.

According to the aspects (2) to (5), because a waiting time period of the cargo transportation vehicle can be extended in response to the request, the convenience of the user is further improved. Further, because a possibility that the cargo will be received by the user is improved, the convenience of an operator is also improved.

According to the aspects (8) to (10), even after the cargo transportation vehicle departs, the cargo transportation vehicle is stopped by the behavior of the user, so that the user can receive the cargo and the convenience of the user is further improved.

According to the aspect (11), the operator can request the user to pay an appropriate fee according to a form in which the cargo has been taken out from the cargo transportation vehicle, so that the convenience of an operator is improved.

According to the aspect (12), even if the cargo transportation is likely to be delayed, a delay can be eliminated by an agile operation of the cargo transportation vehicle.

### BRIEF DESCRIPTION OF THE DRAWINGS

FIG. 1 is a configuration diagram of a transportation system including a management device.

FIG. 2 is a configuration diagram of a cargo transportation vehicle.

FIG. 3 is a diagram showing an example of a structure related to a plurality of storages.

FIG. 4 is a configuration diagram of a management device.

FIG. 5 is a diagram showing an example of content of user information.

FIG. 6 is a diagram showing an example of a transportation service application screen for inputting request information displayed on a display of a terminal device.

FIG. 7 is a diagram showing an example of content of a request information list.

FIG. 8 is a diagram showing an example of content of movement schedule information.

FIG. 9 is a sequence diagram showing an example of a flow of a process executed by a terminal device, a cargo transportation vehicle, and a management device.

FIG. 10 is a flowchart showing an example of a flow of a process executed by the management device.

FIG. 11 is a diagram for describing a process after the cargo transportation vehicle arrives at a delivery point.

FIG. 12 is a diagram showing an example of an image IM1 displayed on the display of the terminal device.

FIG. 13 is a diagram for describing a process (1) in which a cargo transportation vehicle stops after departure.

FIG. 14 is a diagram for describing a process (2) in which the cargo transportation vehicle stops after departure.

FIG. 15 is a diagram for describing a process (3) in which the cargo transportation vehicle stops after departure.

FIG. 16 is a diagram showing an example of content of fee information.

FIG. 17 is a diagram for describing a first operation mode and a second operation mode.

### DETAILED DESCRIPTION

Hereinafter, embodiments of a management device, a management method, and a storage medium of the present invention will be described with reference to the drawings. A cargo transportation vehicle, which is managed by the management device, can autonomously travel on a road in a state in which there is no driver in the vehicle and has a cargo storage shielded by a door capable of being opened and closed.

The cargo transportation vehicle recognizes a situation outside the vehicle using a monitoring unit such as a camera, a radar device, and a light detection and ranging (LIDAR) sensor and moves on the road so that obstacles on the road are avoided while the vehicle travels along a route indicated by the management device as a general rule. In the cargo transportation vehicle, for example, wheels are driven by a motor and move on the road at a speed of about 10 [km/h]. A storage unit of the cargo transportation vehicle forms, for example, a space (an available portion) for loading a plurality of cargo items separated from other spaces. A plurality of users can load cargo into the storage unit and a designated user can unload the cargo from the storage.

The management device manages (controls) an operation of the cargo transportation vehicle. The management device may be a device placed in a place different from that of the cargo transportation vehicle and may communicate with the cargo transportation vehicle via a network or some or all functions of the management device may be provided in the cargo transportation vehicle. The management device generates transportation schedule information, for example, on the basis of request information acquired from a terminal device of a user through communication. The management device issues an instruction to the cargo transportation vehicle with respect to a route and a stop position of the cargo transportation vehicle, an open/closed state of the door of the storage, and the like on the basis of the transportation schedule information.

In the following description, the management device is a device placed in a place different from the cargo transportation vehicle (for example, a device having a form of a cloud server) and is configured to implement the above-described functions by communicating with the terminal device of the user or the cargo transportation vehicle via the network.

### [Overall Configuration]

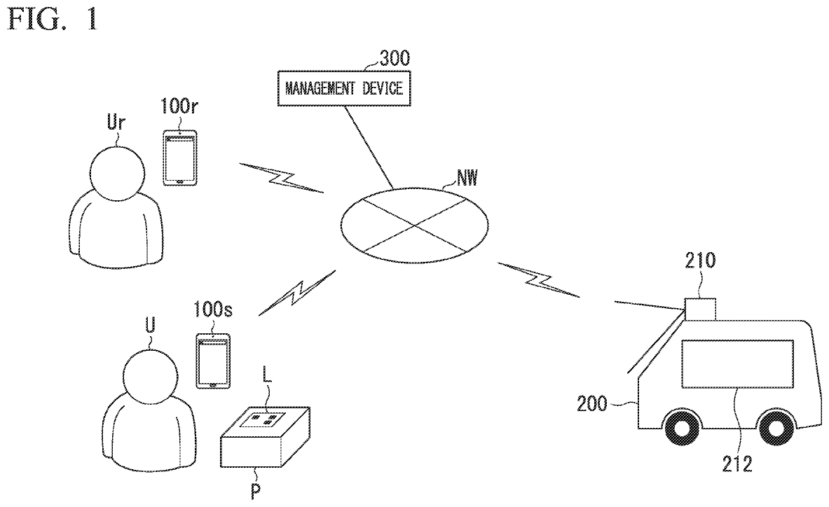

FIG. 1 is a configuration diagram of a transportation system 1 including a management device 300. The transportation system 1 includes one or more cargo transportation vehicles 200 and a management device 300. The management device 300 communicates with a terminal device 100s used by a user U and a terminal device 100r used by a user Ur via a network NW. The network NW includes the Internet, a wide area network (WAN), a local area network (LAN), a public circuit, a provider device, a dedicated circuit, a radio base station and the like. The management device 300 communicates with the cargo transportation vehicle 200 via the network NW. The “terminal device used by the user” is a terminal device, which can be used by an unspecified number of people, such as a terminal device of an Internet cafe, and may include a terminal device that is temporarily used by the user. In any case, the “terminal device of the user” refers to a terminal device in which the user who is performing an operation is identified according to, for example, a login operation of inputting a login name. The user Ur is a recipient of cargo and may be hereinafter referred to as a “recipient.” The user U may be a recipient and the user Ur may be a requester who requests the delivery of the cargo. Hereinafter, when the terminal device 100s and the terminal device 100r are not distinguished, they may be referred to as terminal devices 100. When the user U and the user Ur are not distinguished, they may be simply referred to as users.

The user U transmits request information for requesting the transportation of cargo P to the management device 300 using the terminal device 100. A label L to which identification information of the cargo P and/or the user U is written or which is stored in a built-in IC tag or the like is given to the cargo P. “Given” means, for example, that the label L is attached by a sticker.

The terminal device 100 is, for example, a smartphone, a tablet terminal, a personal computer, or the like. In the terminal device 100, an application program for using the above-described service, a browser, or the like is activated to support services to be described below. In the following description, it is assumed that the terminal device 100 is a smartphone and an application program (a transportation service application) for receiving the service is activated. The transportation service application communicates with the management device 300 in accordance with an operation of the user and transmits request information from the user to the management device 300 or provides information based on the information received from the management device 300. The request information is electronic information for requesting the cargo transportation vehicle 200 to transport the cargo P across a designated section.

### [Cargo Transportation Vehicle]

The cargo transportation vehicle 200 includes a monitoring unit 210 such as a camera, a radar device, or a LIDAR sensor and autonomously travels on the road as described above. A display device 212 may be provided in the cargo transportation vehicle 200. The display device 212 may have a function of a touch panel or may have a function of communicating with a non-contact type IC card embedded therein.

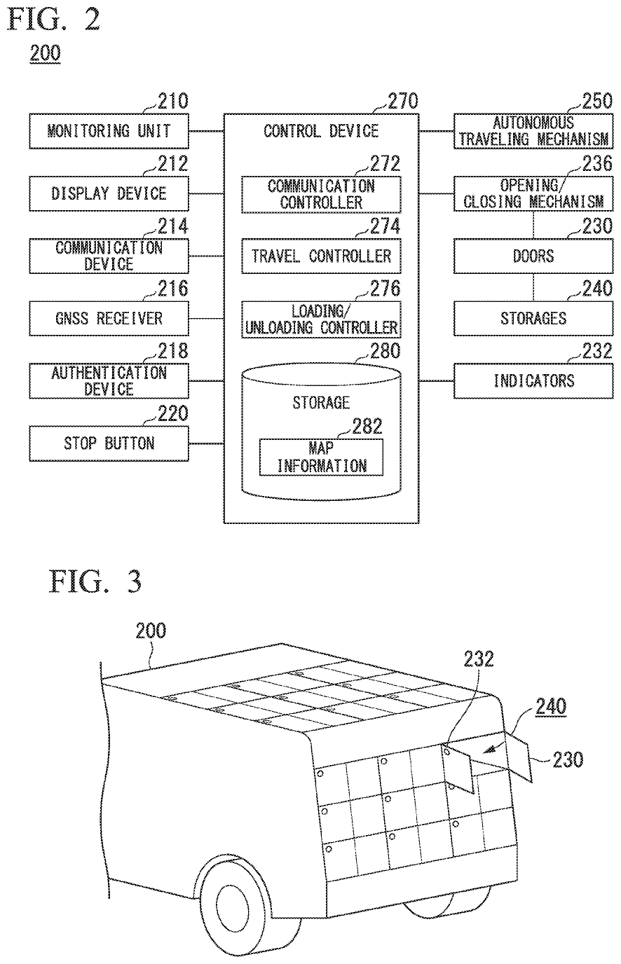

FIG. 2 is a configuration diagram of the cargo transportation vehicle 200. In addition to the above-described monitoring unit 210 and the above-described display device 212, the cargo transportation vehicle 200 includes a communication device 214, a global navigation satellite system (GNSS) receiver 216, an authentication device 218, a stop button 220, an opening/closing mechanism 236, an autonomous traveling mechanism 250, and a control device 270.

The communication device 214 is, for example, a wireless communication module for connecting to the network NW or directly communicating with another vehicle, a terminal device of a pedestrian, or the like. The communication device 214 performs wireless communication on the basis of Wi-Fi, dedicated short range communications (DSRC), Bluetooth (registered trademark), and other communication standards. As the communication device 214, a plurality of communication devices according to purpose of use may be provided.

The GNSS receiver 216 measures a position of its own device (a position of the cargo transportation vehicle 200) on the basis of radio waves received from a GNSS satellite (for example, a GPS satellite). The GNSS receiver 216 outputs a position measurement result to the control device 270.

The authentication device 218 is a device for confirming that a user who intends to load the cargo P into the cargo transportation vehicle 200 or a user who intends to unload the cargo P is an authorized user (or a device for authenticating the user). The authorized user is a user who has made an agreement (reservation) regarding the transportation of cargo with the management device 300. The authentication device 218 may be any device having an authentication function such as a short-range wireless communication device, a biometric authentication device, or a password input device. The authentication device 218 outputs an authentication result to the control device 270.

The stop button 220 is provided on an outer surface of the cargo transportation vehicle 200. The stop button 220 is provided at a position where it can be operated by a user who is not in the cargo transportation vehicle 200 and is outside the vehicle. When the stop button 220 is operated, a stop signal is output to the control device 270. The management device 300 causes the cargo transportation vehicle 200 to stop on the basis of the stop signal.

The opening/closing mechanism 236 is provided for each door 230 and includes a motor, an arm, and the like. The opening/closing mechanism 236 causes the door 230 to be individually opened and closed. For example, a switch for detecting that the door 230 has been manually closed is attached to the door 230. A locking mechanism may be provided in place of (or in addition to) the opening/closing mechanism 236. In this case, when the door of the storage 240 used by the user U is unlocked, an indicator 232 (to be described below) is turned on and the user U manually opens and closes the door 230.

FIG. 3 is a diagram showing an example of a structure related to a plurality of storages 240. The cargo transportation vehicle 200 includes the plurality of storages 240. In the configuration shown in FIG. 3, the cargo transportation vehicle 200 includes nine storages 240 that are open on an upper surface side of the cargo transportation vehicle 200 and nine storages 240 that are open on a rear surface side thereof. A door 230 is provided in each of the storages 240. The door 230 is opened and closed, for example, in the form of a hinged double door and at least a part of the storage 240 is exposed when the door 230 is in the open state. The indicator 232 is attached in correspondence with each storage 240 (for example, on the surface side of each door 230). The indicator 232 includes, for example, a light emitting diode (LED). The indicator 232 is allowed to emit light by the loading/unloading controller 276 so that a loading position of the cargo P to be loaded or a position where the cargo P to be unloaded is stored is indicated. An agreement is established so that each storage 240 stores one item of cargo P or cargo P of one user U. For example, at a cargo collection center, it is possible to recognize whose cargo the cargo P stored in the storage 240 is on the basis of which storage 240 the cargo P is stored in. For example, when a label is given to the cargo P by a worker at the cargo collection center, a delivery destination (an unloading point) can be identified in the subsequent work.

The autonomous traveling mechanism 250 includes wheels, a driving force source such as a motor, an energy storage means such as a battery, a steering mechanism, and the like. The autonomous traveling mechanism 250 causes the cargo transportation vehicle 200 to move in any direction in accordance with an instruction of the control device 270.

The control device 270 includes, for example, a communication controller 272, a travel controller 274, and a loading/unloading controller 276. These components are implemented by, for example, a hardware processor such as a central processing unit (CPU) executing the program (software). Some or all of these components may be implemented, for example, by hardware (a circuit including circuitry) such as a large-scale integration (LSI) circuit, an application specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as a hard disk drive (HDD) or a flash memory or may be stored in a removable storage medium (a non-transitory storage medium) such as a DVD or a CD-ROM and installed in the storage device when the storage medium is mounted in a drive device. The control device 270 has a storage 280 that stores map information 282. The storage 280 is an HDD, a flash memory, a ROM, a random access memory (RAM), or the like.

The communication controller 272 acquires route information from the management device 300 via the communication device 214 and outputs the route information to the travel controller 274. The communication controller 272 uploads position information indicating the position measured by the GNSS receiver 216 to the management device 300 using the communication device 214. The position information is uploaded periodically, for example, in units of milliseconds to seconds.

The travel controller 274 controls the autonomous traveling mechanism 250 so that the cargo transportation vehicle 200 travels along a route designated by the management device 300. For example, the travel controller 274 causes the route acquired from the management device 300 to match the map information 282 and an output of the monitoring unit 210 and determines a detailed route along which the cargo transportation vehicle 200 is to travel. The travel controller 274 sets traveling along the route as a general rule and causes the cargo transportation vehicle 200 to autonomously travel so that contact with a physical object (including a guardrail, a curb, or the like) whose position or speed has been input from the monitoring unit 210 is avoided.

The travel controller 274 causes the cargo transportation vehicle 200 to stop when a stop instruction has been acquired from the management device 300. Instead of this, when the route information includes information about a stop position, the travel controller 274 may cause the cargo transportation vehicle 200 to stop when the position measurement result of the GNSS receiver 216 has matched the stop position. That is, the management device 300 gives the stop instruction or the information about the stop position to the travel controller 274 and the travel controller 274 causes the cargo transportation vehicle 200 to stop in accordance with the stop instruction and the information. A position where the cargo transportation vehicle 200 is stopped includes a position on a road or in a parking lot and a position designated by the user who can stop the vehicle. In particular, when the user U loads the cargo P into the storage 240 of the cargo transportation vehicle 200 or when a recipient designated by the user U unloads the cargo P of the storage 240, the cargo transportation vehicle 200 is stopped on a road or in a parking lot, a designated place, or the like.

For example, the loading/unloading controller 276 drives the indicator 232 or the opening/closing mechanism 236 at a timing indicated by the management device 300 or a predetermined timing.

### [Management Device]

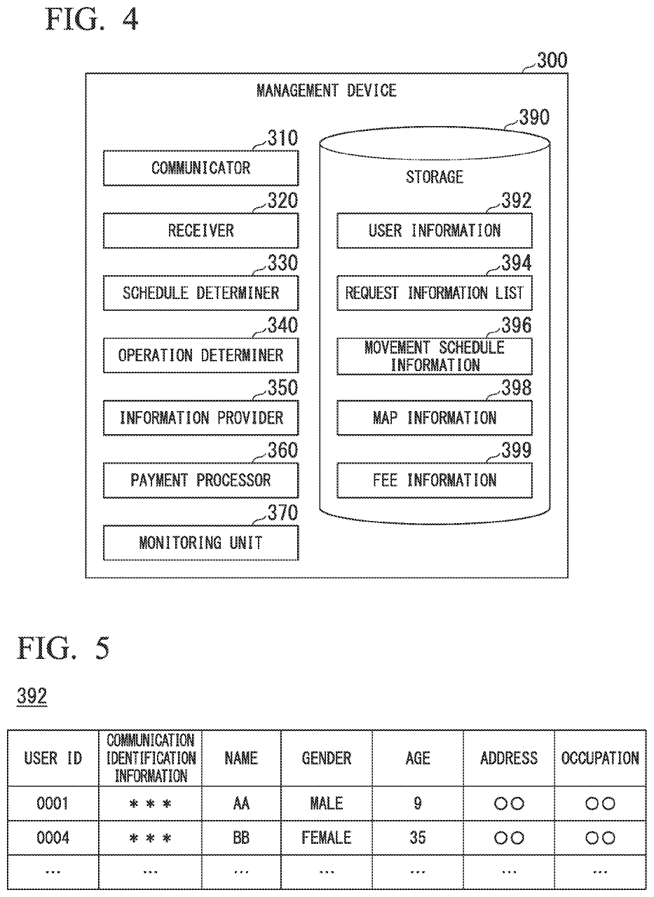

FIG. 4 is a configuration diagram of the management device 300. The management device 300 includes, for example, a communicator 310, a receiver 320, a schedule determiner 330, an operation determiner 340, an information provider 350, a payment processor 360, and a monitoring unit 370. These components are implemented by, for example, a hardware processor such as a CPU executing the program (software). Some or all of these components may be implemented, for example, by hardware (a circuit including circuitry) such as an LSI circuit, an ASIC, an FPGA, or a GPU or may be implemented by software and hardware in cooperation. The program may be pre-stored in a storage device (a storage device including a non-transitory storage medium) such as an HDD or a flash memory or may be stored in a removable storage medium (a non-transitory storage medium) such as a DVD or a CD-ROM and installed in the storage device when the storage medium is mounted in a drive device. The management device 300 may include a storage 390. The storage 390 is implemented by a DVD, a RAM, a flash memory, or the like. Information such as user information 392, a request information list 394, movement schedule information 396, map information 398, and fee information 399 (to be described below) is stored in the storage 390.

FIG. 5 is a diagram showing an example of content of the user information 392. For example, in the user information 392, information such as communication identification information, a name, a gender, age, an address, and an occupation is associated with a user ID which is identification information of the user. Each item of the user information 392 is registered in advance when the user joins a service managed by the management device 300. The communication identification information is information necessary for transmitting information to the terminal device 100 and is information such as an application ID, an Internet protocol (IP) address, a media access control (MAC) address, a mail address, and the like given to an application program.

The communicator 310 is, for example, a network card for connecting to a network NW. The communicator 310 communicates with the terminal device 100 or the cargo transportation vehicle 200 via the network NW.

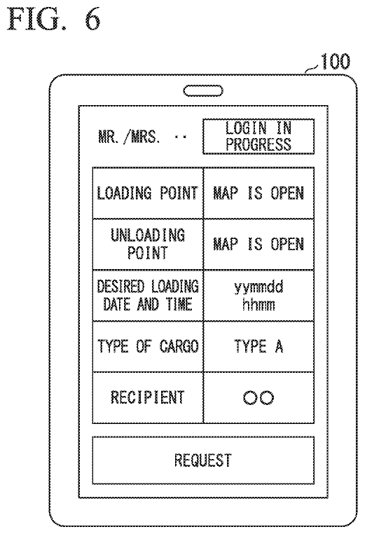

The receiver 320 acquires (receives) request information issued from the terminal device 100 of the user via the communicator 310 and adds the request information to the request information list 394. FIG. 6 is a diagram showing an example of a transportation service application screen for inputting request information displayed on the display of the terminal device 100. As shown in FIG. 6, a loading point (first designation information), an unloading point (second designation information), a desired loading time, a type of cargo indicating a size or a shape of the cargo, identification information of a recipient (a user) who receives the cargo, and the like can be input on the transportation service application screen and the information input by the user U is transmitted as the request information to the management device 300. The loading point or the unloading point is input by, for example, the terminal device 100 displaying a map and the user U designating a point on the map. The recipient may operate the terminal device 100r to designate the unloading point.

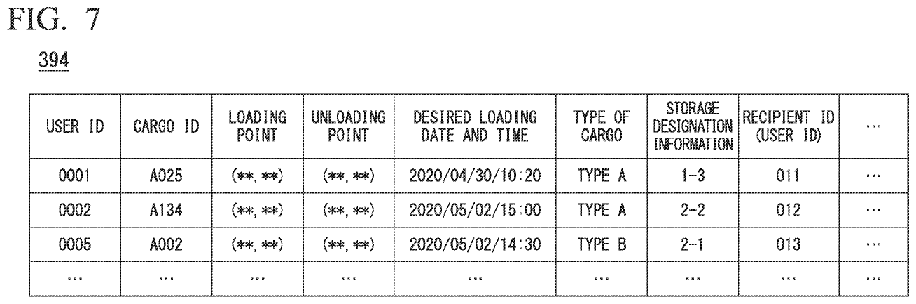

FIG. 7 is a diagram showing an example of content of the request information list 394. The request information list 394 is, for example, information in which a user ID of a user who has transmitted request information, a cargo ID which is identification information of cargo, a loading point which is a start point of a section related to the transportation of the cargo, an unloading point which is an end point of the section, a desired loading time, a type of cargo, storage designation information, recipient identification information (a recipient ID), and the like are mutually associated. A set of a user ID, a cargo ID, a loading point, an unloading point, a desired loading time, a type of cargo, and a recipient ID related to one request information element is referred to as a record. The cargo ID is given by the receiver 320. The request information is any format of information including content required to generate a record. The storage designation information is information indicating which storage 240 is assigned. In FIG. 7, “1” of “1-3” indicates the upper surface side of the cargo transportation vehicle 200 and “−3” indicates one of the nine storages on the upper surface side. “2” of “2-2” indicates the rear surface side of the cargo transportation vehicle 200 and “−2” indicates one of the nine storages on the rear surface side.

The storage designation information is determined by, for example, the schedule determiner 330. When the storage designation information is determined in correspondence with the request information received from the user U, the schedule determiner 330 transmits determination content to the terminal device 100 of the user. The terminal device 100 displays information indicating the determination content. Thereby, the user U can recognize in advance a position of the storage 240 where the cargo P is required to be stored. This storage designation information is also transmitted to the terminal device 100 associated with a recipient ID. The recipient of the recipient ID can take out the cargo from the storage 240 with reference to the storage designation information. For example, the recipient performs authentication by inputting a password provided by the management device 300 to the authentication device 218 or transmitting the recipient ID from the terminal device 100 to the authentication device 218. After the authentication is completed, the loading/unloading controller 276 causes the opening/closing mechanism 236 to be driven and causes the door 230 designated in the storage designation information to be open. Thereby, the recipient can unload the cargo. When the cargo is unloaded and the recipient closes the door, the cargo transportation vehicle 200 determines that the cargo has been taken out and starts traveling toward the next destination.

When a new request information record is added to the request information list 394, the schedule determiner 330 refers to a list of cargo transportation vehicles 200 (not shown) and the movement schedule information 396 and selects a cargo transportation vehicle 200 to be used for the user U related to the request information from among a plurality of cargo transportation vehicles 200. For example, the schedule determiner 330 determines whether or not it is appropriate to incorporate the collection of cargo P in the existing movement schedule of the cargo transportation vehicle 200 already incorporated in the movement schedule information 396 after the number of cargo transportation vehicles 200 capable of transporting the cargo P is narrowed down with reference to a type of cargo included in the request information, adds the collection of the cargo P to the existing movement schedule if it is appropriate, and registers the collection of the cargo P by setting a movement schedule of a new cargo transportation vehicle 200 otherwise. The storage designation information is determined as described above and is transmitted to the terminal device 100 of the user U.

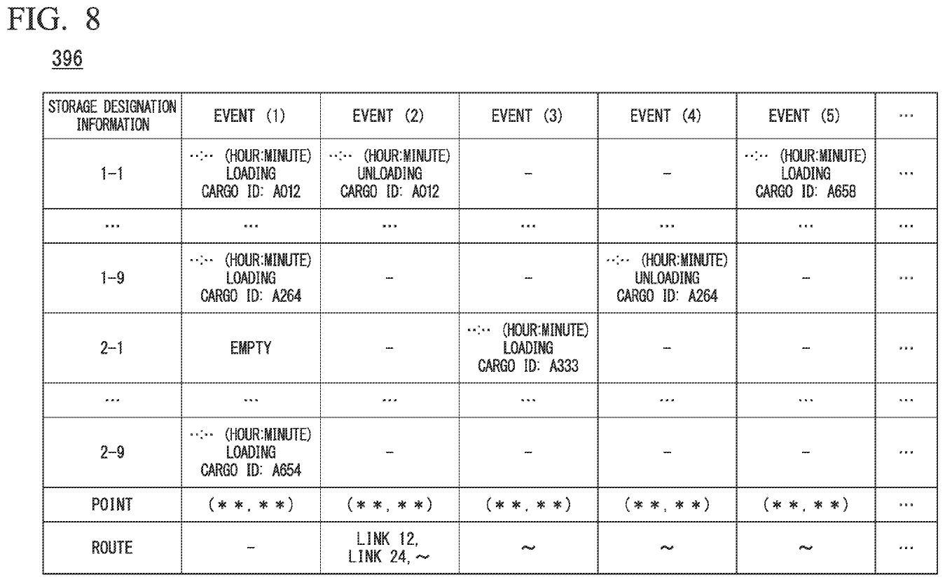

FIG. 8 is a diagram showing an example of content of the movement schedule information 396. In the movement schedule information 396, a daily schedule is set as one unit with respect to each of the cargo transportation vehicles 200. In the movement schedule information 396, an estimated time, information indicating loading or unloading, a cargo ID of cargo P to be transported, a point where loading or unloading is performed, information of a route between points (for example, a route from a previous event to a current event), and the like are associated with an event in which loading or unloading is performed (hereinafter, the event may be referred to as a loading event or a unloading event) with respect to each of the storages 240. The route is represented by, for example, a sequential arrangement of links in the map information 398. For example, after records of request information are roughly grouped according to each of a date, a time period, and a region, the schedule determiner 330 sets some movement patterns in which a plurality of loading points and a plurality of desired loading times are sequentially arranged, extracts a movement pattern whose movement cost is lowest with reference to the map information 398, and adds the extracted movement pattern to the movement schedule information 396. As for a movement cost calculation technique or a movement cost evaluation technique, various techniques are known in the field of the navigation system and thus description thereof will be omitted.

The operation determiner 340 transmits an operation instruction to the cargo transportation vehicle 200 using the communicator 310 on the basis of the movement schedule information 396 as described above. That is, the operation determiner 340 determines the operation of the cargo transportation vehicle 200 on the basis of the movement schedule information 396 generated on the basis of the request information received by the receiver 320. The operation of the cargo transportation vehicle 200 determined by the operation determiner 340 includes content indicating a stop instruction (which may indicate a stop timing or may be left to the determination of the cargo transportation vehicle 200 in a state in which a point is indicated) at the route, the loading point or the unloading point, content indicating which storage 240 is in an empty state at the loading point or the unloading point, and the like.

As shown in FIG. 8, in relation to the storage 240 whose storage designation information is “1-1,” the movement schedule information 396 is set so that cargo P whose cargo ID is “A012” is loaded in an event (1) and unloaded after the transportation in an event (2) and then cargo P whose cargo ID is “A658” is loaded in an event (5). In relation to the storage 240 whose storage designation information is “2-1,” while the cargo P is delivered in another storage 240, cargo P whose cargo ID is “A333” is loaded in an event (3). According to this, the operation determiner 340 causes the cargo transportation vehicle 200 by which the cargo P is being delivered to collect new cargo P. The operation determiner 340 issues an instruction to the opening/closing mechanism 236, which is a driver of the door 230, so that the new cargo P which is collected is loaded into the storage 240 in an empty state according to the delivery of the cargo transportation vehicle 200 by which the cargo P is being delivered. As a result, convenience can be improved.

The information provider 350 provides position information or route information of the cargo transportation vehicle 200 to the terminal device 100 of the user (the terminal device 100 of the user U who is the requester or the recipient). The information provider 350 transmits the position information uploaded using the communication device 214 according to the communication controller 272 of the cargo transportation vehicle 200 or the route information described in the movement schedule information 396 to the terminal device 100 using the communicator 310. For example, the information provider 350 transmits information for displaying an image showing position information or route information superimposed on a map image to the terminal device 100.

The payment processor 360 performs a process of collecting a fee from the user U or the recipient. For example, the payment processor 360 cooperates with a credit card or electronic money management server to collect a fee from the user U or the recipient.

The monitoring unit 370 acquires an image acquired by the monitoring unit 210 of the cargo transportation vehicle 200, analyzes the acquired image, and identifies the user's behavior or the intention indicated by the user's behavior. Details of this process will be described below.

### [Sequence]

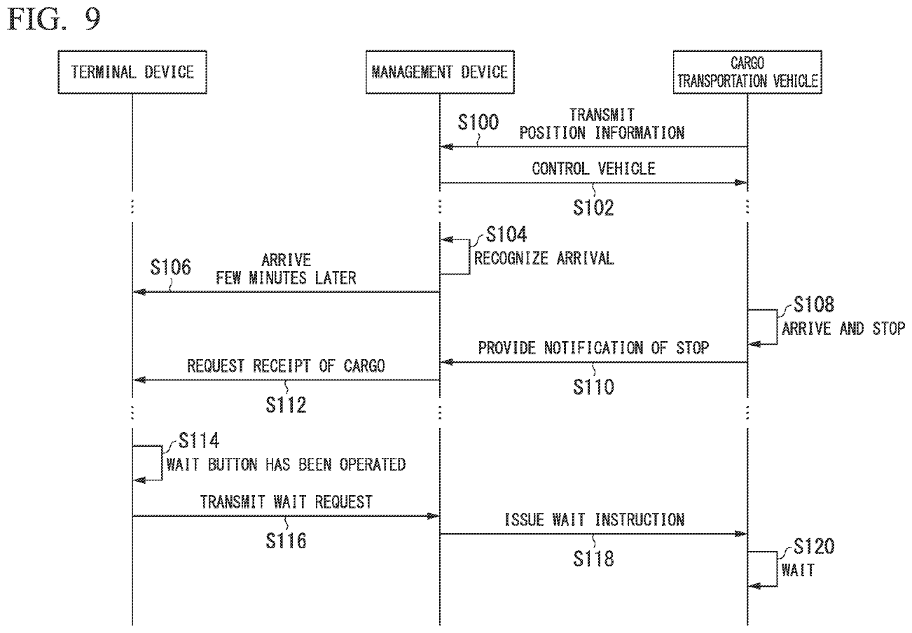

FIG. 9 is a sequence diagram showing an example of a flow of a process executed by the terminal device 100, the cargo transportation vehicle 200, and the management device 300. This is a process executed when the cargo P is transported to a predetermined delivery point (an unloading point or a delivery destination) on the basis of the movement schedule information 396.

The cargo transportation vehicle 200 transmits position information to the management device 300 at each predetermined interval (step S100). The management device 300 controls the cargo transportation vehicle 200 so that the cargo transportation vehicle 200 is allowed to travel toward a predetermined delivery point on the basis of the position information acquired in step S100 (step S102).

Next, the management device 300 recognizes that the cargo transportation vehicle 200 arrives at a predetermined delivery point on the basis of the position information transmitted by the cargo transportation vehicle 200 (step S104). For example, the management device 300 recognizes that the cargo transportation vehicle 200 will arrive at the predetermined delivery point a few minutes later.

Next, the management device 300 notifies the terminal device 100 that the cargo transportation vehicle 200 will arrive at the predetermined delivery point a few minutes later (step S106). The terminal device 100 is the terminal device 100 of the recipient that receives cargo at the predetermined delivery point, and is, for example, a terminal device 100 associated with user information 392.

When the cargo transportation vehicle 200 arrives at the predetermined delivery point and stops (step S108), the management device 300 is notified that the cargo transportation vehicle 200 has stopped at the predetermined delivery point (step S110). The management device 300 provides information for requesting the terminal device 100 to receive the cargo on the basis of the notification transmitted by the cargo transportation vehicle 200 (step S112). The information provider 350 of the management device 300 provides the terminal device 100 of the recipient of the cargo with a time at which the cargo transportation vehicle 200 will arrive at a delivery destination of the cargo. The time is provided by e-mail, by displaying a predetermined image on the display of the terminal device 100, by automated phone communication, or the like.

When the recipient has taken out the cargo from the cargo transportation vehicle 200 after the processing of step S112, the cargo transportation vehicle 200 starts traveling toward the next destination. When the cargo is not taken out within a predetermined time period after the cargo transportation vehicle 200 stops, the cargo transportation vehicle 200 starts traveling toward the next destination in a state in which the cargo is loaded.

When the recipient operates a “wait button” displayed on the display of the terminal device 100 within a predetermined time period after the cargo transportation vehicle 200 stops (step S114), the terminal device 100 transmits a wait request to the management device 300 (step S116). The wait request is a request for causing the cargo transportation vehicle 200 to wait so that the cargo transportation vehicle 200 does not depart.

Next, the management device 300 instructs the cargo transportation vehicle 200 to wait in response to the wait request (step S118). On the basis of the instruction of step S118, the cargo transportation vehicle 200 waits for a time period according to the wait request (step S120). The operation determiner 340 extends a time period for causing the cargo transportation vehicle 200 to wait in response to the wait request.

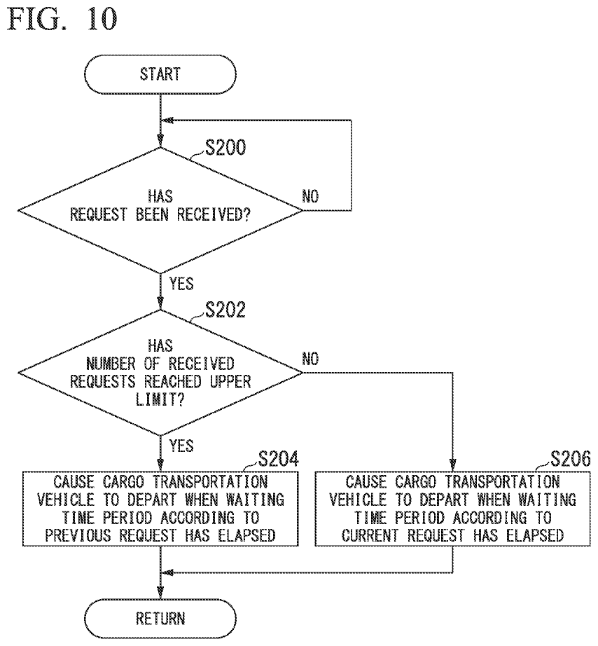

Here, a process related to the wait request will be described. FIG. 10 is a flowchart showing an example of a flow of a process executed by the management device 300.

First, the receiver 320 of the management device 300 determines whether or not the wait request has been received (step S200). When the wait request has been received, the operation determiner 340 determines whether or not the number of received wait requests has reached an upper limit (step S202). When the number of received wait requests has reached the upper limit, the operation determiner 340 causes the cargo transportation vehicle 200 to depart when a waiting time period according to a previous wait request has elapsed without receiving the current wait request (step S204).

When the number of received wait requests has not reached the upper limit, the operation determiner 340 receives the current wait request and causes the cargo transportation vehicle 200 to depart when a waiting time period according to the current wait request has elapsed (step S206). In this way, the extension of the waiting time period based on the wait request is performed a number of times of an upper limit and the extension of the waiting time period exceeding the upper limit is not allowed. Thereby, the process of one routine of the present flowchart ends.

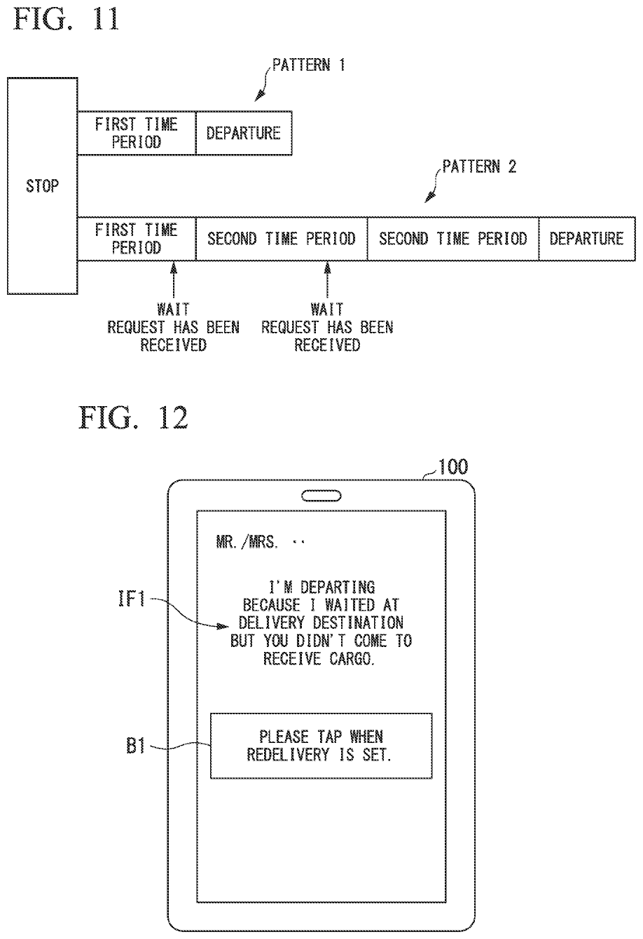

FIG. 11 is a diagram for describing a process after the cargo transportation vehicle 200 arrives at a delivery point. For example, as shown in pattern 1, when the recipient does not come to receive cargo even though a first time period has elapsed after the cargo transportation vehicle 200 stopped at the delivery point, the cargo transportation vehicle 200 departs. For example, as shown in pattern 2, when the management device 300 has received a wait request before the elapse of the first time period after the cargo transportation vehicle 200 stopped at the delivery point, the cargo transportation vehicle 200 waits for a second time period after the elapse of the first time period. When the wait request is further received for the second time period, the management device 300 causes the cargo transportation vehicle 200 to further wait for an additional second time period after the elapse of the second time period if the number of received wait requests has not reached the upper limit. The second time period is longer than the first time period.

The management device 300 causes the cargo transportation vehicle 200 to depart when the second time period has elapsed or when the first time period has elapsed in a state in which cargo has not been taken out from the cargo transportation vehicle 200. For example, when the cargo transportation vehicle 200 has departed, the management device 300 causes the cargo transportation vehicle 200 to travel toward a predetermined shop (for example, a convenience store or the like) or a designated place (for example, a business office or the like) so that the cargo is transported to the shop or the designated place for a recipient to receive the cargo.

For example, when the cargo transportation vehicle 200 has arrived at the delivery point, the recipient may go to the toilet, take a shower, or sleep. In this case, a time period longer than the first time period may be required for the recipient to get out of a building. In the above-described situation, the recipient operates the wait button before the first time period elapses, so that the cargo transportation vehicle 200 waits for the second time period even if the first time period elapses. Thereby, the recipient can receive the cargo, for example, after getting out of a shower room, wiping his or her body, and changing his or her clothes.

As described above, even if the recipient cannot receive the cargo immediately, he or she can receive the cargo by operating the wait button and the convenience of the recipient (the user) is improved. Because a service operator can deliver the cargo to the recipient without taking the cargo back, the time and effort of redelivery is eliminated and the convenience or efficiency for the service operator is also improved.

### [Process Related to Redelivery]

When the recipient cannot receive the cargo and the cargo transportation vehicle 200 has departed after the elapse of the first time period or the second time period, the management device 300 causes the display of the terminal device 100 to display an image IM. The image IM is an example of an image including specific information.

FIG. 12 is a diagram showing an example of the image IM1 displayed on the display of the terminal device 100. The image IM1 includes information IF1 indicating that the recipient is unable to receive the cargo from the cargo transportation vehicle 200 and the cargo transportation vehicle 200 has departed and a redelivery button B1 for setting redelivery. For example, an image for the recipient to designate a date and time of redelivery is displayed on the display of the terminal device 100 when the recipient operates the button B1 and the management device 300 causes the cargo transportation vehicle 200 to deliver the undelivered cargo on the date and time of the redelivery when the recipient designates the date and time of redelivery.

[Process in which Cargo Transportation Vehicle Stops after Departure]

The operation determiner 340 of the management device 300 causes the cargo transportation vehicle 200 to stop at a predetermined position so that the recipient can receive the cargo when the monitoring unit 370 has acquired information indicating that the recipient is approaching the cargo transportation vehicle 200 or information indicating that the recipient intends to receive the cargo (for example, when the stop button 220 has been operated or a predetermined operation has been performed on the terminal device 100) after the cargo transportation vehicle 200 departed from the delivery point without the cargo being taken out from the cargo transportation vehicle.

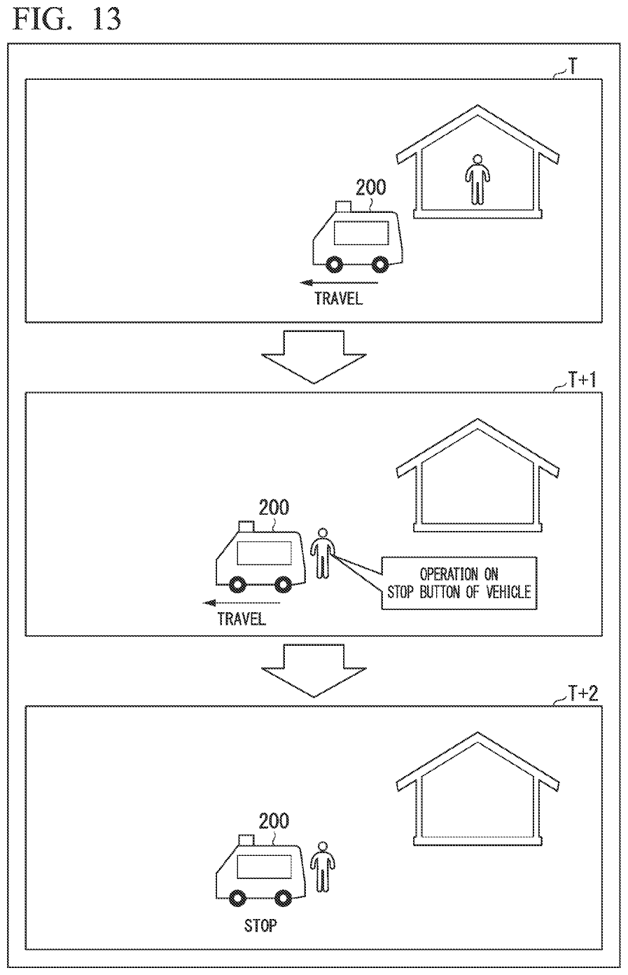

FIG. 13 is a diagram for describing a process (1) in which the cargo transportation vehicle 200 stops after departure. At time T, the cargo transportation vehicle 200 departs in a state in which the recipient has not received the cargo. Subsequently, at time T+1, the recipient has operated the stop button 220 after chasing the cargo transportation vehicle 200 and catching up with the cargo transportation vehicle 200. At time T+2, the cargo transportation vehicle 200 stops. Thereby, the recipient can receive the cargo from the cargo transportation vehicle 200. When the cargo transportation vehicle 200 has traveled for a predetermined time period after departure or has traveled a predetermined distance after departure, the traveling may be continued even if the stop button 220 is operated.

As described above, even if the cargo transportation vehicle 200 departs, the recipient can cause the cargo transportation vehicle 200 to stop by operating the stop button 220. Thereby, the convenience of the recipient is improved.

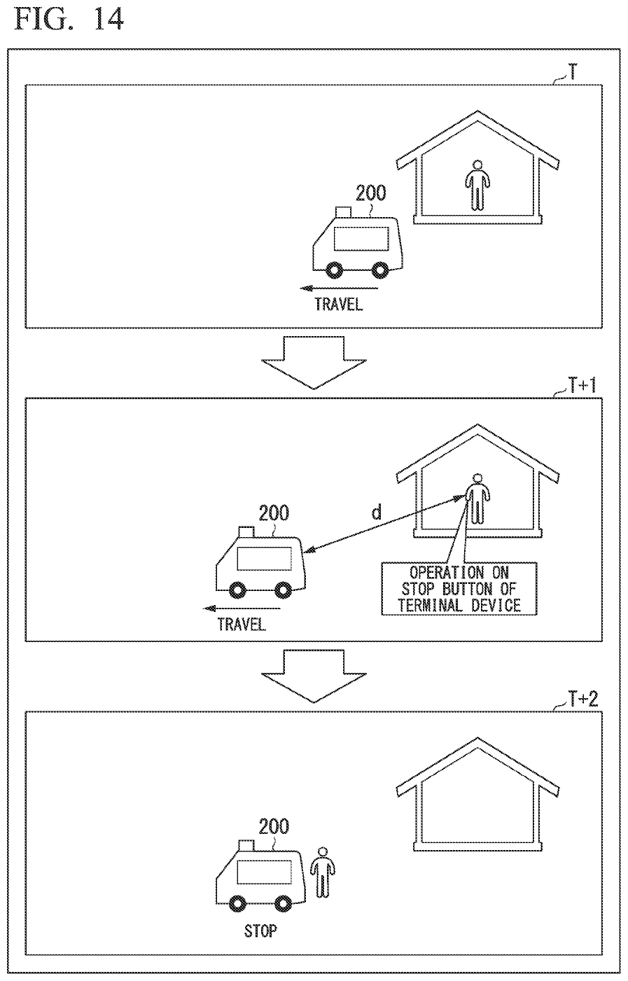

FIG. 14 is a diagram for describing a process (2) in which the cargo transportation vehicle 200 stops after departure. At time T, the cargo transportation vehicle 200 departs in a state in which the recipient has not received the cargo. Subsequently, at time T+1, the recipient has operated the stop button displayed on the display of the terminal device 100 by operating the terminal device 100.

At time T+2, the cargo transportation vehicle 200 stops. Thereby, the recipient can receive the cargo from the cargo transportation vehicle 200. However, when the stop button has been operated, the management device 300 causes the cargo transportation vehicle 200 to continuously travel without causing the cargo transportation vehicle 200 to stop when a distance between the terminal device 100 and the cargo transportation vehicle 200 is greater than or equal to a distance d (or when a predetermined time period has elapsed after the cargo transportation vehicle 200 departed). The management device 300 identifies the distance between the terminal device 100 and the cargo transportation vehicle 200 on the basis of acquired position information of the terminal device 100 and acquired position information of the cargo transportation vehicle 200.

As described above, even if the cargo transportation vehicle 200 departs, the recipient can cause the cargo transportation vehicle 200 to stop by operating the stop button of the terminal device 100. Thereby, the convenience of the recipient is improved. Further, when the distance between the terminal device 100 and the cargo transportation vehicle 200 is large, it takes time for the recipient to come to the position of the cargo transportation vehicle 200, so that the cargo transportation vehicle 200 continuously travels without stopping and therefore the convenience of the user and the operational efficiency can be balanced.

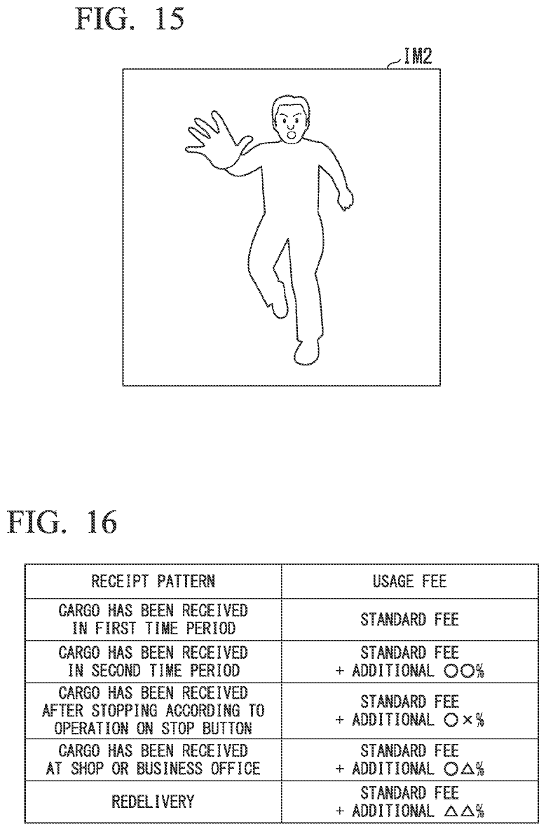

FIG. 15 is a diagram for describing a process (3) in which the cargo transportation vehicle 200 stops after departure. When the monitoring unit 370 has acquired information indicating that the recipient is approaching the cargo transportation vehicle 200, the operation determiner 340 causes the cargo transportation vehicle 200 to stop. The monitoring unit 370 acquires, for example, an image by imaging surroundings of the cargo transportation vehicle 200 from the monitoring unit 210 (for example, an image IM2 of FIG. 15). The monitoring unit 370 analyzes the acquired image and determines whether or not the recipient is chasing the cargo transportation vehicle 200 to receive the cargo. The operation determiner 340 causes the cargo transportation vehicle 200 to stop when the monitoring unit 370 determines that the recipient is chasing the cargo transportation vehicle 200 to receive the cargo and does not cause the cargo transportation vehicle 200 to stop when the monitoring unit 370 determines that the recipient is not chasing the cargo transportation vehicle 200 to receive the cargo.

For example, the monitoring unit 370 determines whether or not a person included in the image is chasing the cargo transportation vehicle 200 to receive the cargo using a technique such as pattern matching or deep learning. The monitoring unit 370 may determine whether or not the recipient is chasing the cargo transportation vehicle 200 with reference to a history of the position information of the terminal device 100. The cargo transportation vehicle 200 may have some or all of the functions of the monitoring unit 370 and the cargo transportation vehicle 200 may determine whether or not the recipient is chasing the cargo transportation vehicle 200.

As described above, even if the cargo transportation vehicle 200 departs, the recipient can stop the cargo transportation vehicle 200 by chasing the cargo transportation vehicle 200. Thereby, the convenience of the recipient is improved.

### [Determination of Usage Fee]

The payment processor 360 determines a usage fee with reference to the fee information 399. FIG. 16 is a diagram showing an example of content of the fee information 399. The fee information 399 is information in which receipt patterns (1) to (5) and usage fees are associated with each other.

(1) For example, if the recipient receives the cargo within the first time period after the cargo transportation vehicle 200 arrives at the delivery point, the usage fee is a standard fee.

(2) For example, when the recipient has received the cargo within the second time period after operating the wait button to make a wait request, the usage fee is a fee obtained by adding +OX % to the standard fee. The usage fee may increase as the number of wait requests increases or the usage fee may be the standard fee even if the wait request is made.

(3) For example, when the recipient has operated the stop button to stop the cargo transportation vehicle 200 and has received the cargo, the usage fee is a fee obtained by adding +OX % to the standard fee. In this case, the usage fee may be the standard fee.

(4) For example, when the recipient has received the cargo at a shop or a business office later without receiving the cargo at the time of the arrival of the cargo transportation vehicle 200, the usage fee is a fee obtained by adding +OΔ % to the standard fee.

(5) For example, if the recipient has received the cargo when the cargo has been redelivered without receiving the cargo at the time of the arrival of the cargo transportation vehicle 200, the usage fee is a fee obtained by adding +OΔ % to the standard fee.

The usage fee may be higher in the order of the above-described (1), (2), (3), (4), and (5), the usage fee in the case of the above-described (5) is the highest and the others may be arbitrary. The usage fees in the case of the above-described (1) and (2) or (1), (2), and (3) may be the same.

[Operation Mode after Cargo Transportation Vehicle Departs without Taking Out Cargo]

The operation determiner 340 causes the cargo transportation vehicle 200 to be operated in a first operation mode after the cargo transportation vehicle 200 departs from the delivery destination in a state in which cargo is taken out from the cargo transportation vehicle 200 when the cargo transportation vehicle 200 has arrived at the delivery destination and causes the cargo transportation vehicle 200 to be operated in a second operation mode having higher agility than the first operation mode after the cargo transportation vehicle 200 departs from the delivery destination in a state in which cargo is not taken out from the cargo transportation vehicle 200 when the cargo transportation vehicle 200 has arrived at the delivery destination.

The usage fee is higher than the standard fee, for example, in a delivery mode after the cargo transportation vehicle 200 departs from the delivery destination in a state in which cargo is not taken out from the cargo transportation vehicle 200 when the cargo transportation vehicle 200 has arrived at the delivery destination. For example, this is a case in which the cargo has not been received within the first time period. Specifically, when the cargo has been received in the second time period, when the cargo has been taken out after the cargo transportation vehicle 200 was stopped in accordance with the operation of the stop button, and when the cargo transportation vehicle 200 is scheduled to transport undelivered cargo to a shop or a business office or the cargo transportation vehicle 200 is scheduled to redelivery undelivered cargo, the cargo transportation vehicle 200 operates in the second operation mode.

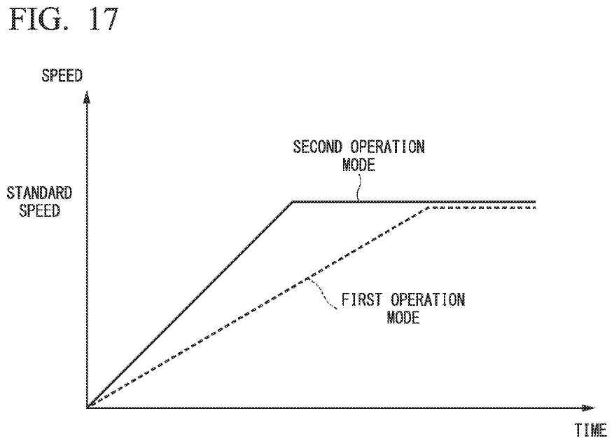

FIG. 17 is a diagram for describing the first operation mode and the second operation mode. The vertical axis of FIG. 17 represents the speed of the cargo transportation vehicle 200 and the horizontal axis of FIG. 17 represents the time. For example, a time period required for the cargo transportation vehicle 200 to reach a standard speed in the second operation mode is shorter than a time period required for the cargo transportation vehicle 200 to reach the standard speed in the first operation mode. Because a degree of acceleration of the second operation mode is higher than a degree of acceleration of the first operation mode, the cargo transportation vehicle 200, which operates in the second operation mode, operates more agilely than the cargo transportation vehicle 200, which operates in the first operation mode. A degree of deceleration of the second operation mode may be higher than a degree of deceleration of the first operation mode. Agility means that a degree of deceleration, a degree of acceleration, a speed, or the like is higher.

As described above, because an amount of work for performing the service is not reduced when the cargo cannot be delivered to the recipient, the management device 300 causes the cargo transportation vehicle 200 to be agilely operated in the second operation mode and the work can be done more quickly. As a result, the management device 300 enables the cargo to be delivered according to the schedule.

As described above, when the cargo transportation vehicle 200 operates in the second operation mode, fuel efficiency (or electricity efficiency) may decrease. However, when the cargo transportation vehicle 200 travels in the second operation mode, the recipient pays a fee higher than the standard fee, so that a difference between this standard fee and a fee including an additional fee compensates for the cost of the decrease in the fuel efficiency.

According to the embodiment described above, the management device 300 provides a time at which the cargo transportation vehicle 200 will arrive at the delivery destination of the cargo to the terminal device 100 of the recipient of the cargo and determines an operation of the cargo transportation vehicle 200 so that the cargo transportation vehicle 200 arrives at the delivery destination at the time of arrival, so that the convenience of the user is improved.

Some of the functions included in the management device 300 may be provided in the cargo transportation vehicle 200. For example, some or all of the receiver 320, the operation determiner 340, the information provider 350, the payment processor 360, and the monitoring unit 370 or some or all of the functions of these functional units may be provided in the cargo transportation vehicle 200. A part or all of the information stored in the storage 390 of the management device 300 may be stored in the storage 280 of the cargo transportation vehicle 200.

The above-described embodiment can be implemented as follows.

A management device for managing an operation of a cargo transportation vehicle that autonomously travels on a road in a state in which there is no driver in the cargo transportation vehicle and that is able to store cargo in each of a plurality of storages shielded by doors that are opened and closed, the management device including:

a storage device storing a program; and

a hardware processor,

wherein the hardware processor executes the program stored in the storage device to:

receive request information about transportation of the cargo from a user;

provide a time at which the cargo transportation vehicle will arrive at a delivery destination of the cargo to a terminal device of a recipient of the cargo; and

determine the operation of the cargo transportation vehicle so that the cargo transportation vehicle arrives at the delivery destination at the time.

Although modes for carrying out the present invention have been described above using the embodiments, the present invention is not limited to the embodiments and various modifications and replacements can be applied without departing from the spirit and scope of the present invention.

What is claimed is:

1. A management device for managing an operation of a cargo transportation vehicle that autonomously travels on a road in a state in which there is no driver in the cargo transportation vehicle and that is able to store cargo in each of a plurality of storages shielded by doors that are opened and closed, the management device comprising:
a receiver configured to receive request information about transportation of the cargo from a user;
an information provider configured to provide a time at which the cargo transportation vehicle will arrive at a delivery destination of the cargo to a terminal device of a recipient of the cargo; and
an operation determiner configured to determine the operation of the cargo transportation vehicle so that the cargo transportation vehicle arrives at the delivery destination at the time.

2. The management device according to claim 1,
wherein, when the cargo transportation vehicle has arrived at the delivery destination, the operation determiner causes the cargo transportation vehicle to depart from the delivery destination after the cargo transportation vehicle is allowed to wait for a predetermined time period,
wherein the receiver receives a request for extending a time period for which the cargo transportation vehicle is allowed to wait near the delivery destination after the cargo transportation vehicle arrives at the delivery destination, and
wherein the operation determiner extends the time period for which the cargo transportation vehicle is allowed to wait in response to the received request.

3. The management device according to claim 2, wherein an upper limit is defined in the number of received requests for the extension.

4. The management device according to claim 2,
wherein the operation determiner causes the cargo transportation vehicle to depart from the delivery destination when the receiver has not received the request, the cargo has not been taken out from the cargo transportation vehicle, and a first time period has elapsed from the time at which the cargo transportation vehicle has arrived at the delivery destination, and
wherein the operation determiner causes the cargo transportation vehicle to depart from the delivery destination when the receiver has received the request, the cargo has not been taken out from the cargo transportation vehicle, and a second time period has elapsed from an end point of the first time period.

5. The management device according to claim 4, wherein the second time period is longer than the first time period.

6. The management device according to claim 2,
wherein the information provider provides the terminal device of the recipient with a notification including specific information indicating that receipt has not been performed when the cargo transportation vehicle has departed from the delivery destination in a state in which the cargo has not been taken out from the cargo transportation vehicle, and
wherein the specific information includes a screen in which redelivery of the cargo is able to be set and information for accessing the screen.

7. The management device according to claim 6, wherein the operation determiner causes the cargo transportation vehicle to travel toward a predetermined shop or a designated place so that the cargo is transported to the shop or the designated place for the recipient to receive the cargo at the shop or the designated place when the cargo transportation vehicle has departed from the delivery destination in a state in which the cargo has not been taken out from the cargo transportation vehicle.

8. The management device according to claim 2, further comprising a behavior information acquirer configured to acquire information of behavior of the recipient,
wherein, after the cargo transportation vehicle departs from the delivery destination in a state in which the cargo has not been taken out from the cargo transportation vehicle, the operation determiner causes the cargo transportation vehicle to stop at a predetermined position so that the recipient receives the cargo when the behavior information acquirer has acquired information indicating that the recipient is approaching the cargo transportation vehicle or information indicating that the recipient intends to receive the cargo.

9. The management device according to claim 2, wherein the operation determiner causes the cargo transportation vehicle to stop at a predetermined position when a first button provided in the cargo transportation vehicle or a second button displayed on a display of the terminal device of the recipient has been operated within a predetermined period from the departure of the cargo transportation vehicle from the delivery destination or while the cargo transportation vehicle travels a predetermined distance from the departure from the delivery destination.

10. The management device according to claim 9,
wherein the operation determiner causes the cargo transportation vehicle to stop at the predetermined position when the second button displayed on the display of the terminal device of the recipient present within the predetermined distance from the cargo transportation vehicle has been operated, and
wherein the operation determiner does not cause the cargo transportation vehicle to stop at the predetermined position when the second button displayed on the display of the terminal device of the recipient absent within the predetermined distance from the cargo transportation vehicle has been operated.

11. The management device according to claim 1, further comprising a fee processor configured to request the recipient to pay an additional fee when the recipient has received the cargo after the cargo transportation vehicle departed from the delivery destination in a state in which the cargo was not taken out from the cargo transportation vehicle when the cargo transportation vehicle arrived at the delivery destination.

12. The management device according to claim 11,
wherein the operation determiner causes the cargo transportation vehicle to be operated in a first operation mode after the cargo transportation vehicle departs from the delivery destination in a state in which the cargo is taken out from the cargo transportation vehicle when the cargo transportation vehicle has arrived at the delivery destination; and
wherein the operation determiner causes the cargo transportation vehicle to be operated in a second operation mode having higher agility than the first operation mode after the cargo transportation vehicle departs from the delivery destination in a state in which the cargo is not taken out from the cargo transportation vehicle when the cargo transportation vehicle has arrived at the delivery destination.

13. A management method comprising:
receiving, by a management device, request information about transportation of cargo from a user, the management device managing an operation of a cargo transportation vehicle that autonomously travels on a road in a state in which there is no driver in the cargo transportation vehicle and that is able to store cargo in each of a plurality of storages shielded by doors that are opened and closed;
providing, by the management device, a time at which the cargo transportation vehicle will arrive at a delivery destination of the cargo to a terminal device of a recipient of the cargo; and
determining, by the management device, the operation of the cargo transportation vehicle so that the cargo transportation vehicle arrives at the delivery destination at the time.

14. A non-storage medium storing a program for causing a computer of a management device for managing an operation of a cargo transportation vehicle that autonomously travels on a road in a state in which there is no driver in the cargo transportation vehicle and that is able to store cargo in each of a plurality of storages shielded by doors that are opened and closed, to execute processes of:
receiving request information about transportation of the cargo from a user;
providing a time at which the cargo transportation vehicle will arrive at a delivery destination of the cargo to a terminal device of a recipient of the cargo; and
determining the operation of the cargo transportation vehicle so that the cargo transportation vehicle arrives at the delivery destination at the time.
